(19) United States
(12) Patent Application Publication
(10) Pub. No.: US 2024/0311664 A1
(43) Pub. Date: Sep. 19, 2024

(54) MANAGEMENT CONSULTING DIGITAL ASSISTANT

(71) Applicant: SAUDI ARABIAN OIL COMPANY, Dhahran (SA)

(72) Inventors: Mark A. Stanley, Al Khubar (SA); Mohammad Tayyab, Al Khubar (SA); Syed M. Mukhtar, Dhahran (SA); Fatimah M. Haboubi, Dhahran (SA)

(73) Assignee: SAUDI ARABIAN OIL COMPANY, Dhahran (SA)

(21) Appl. No.: 18/185,666

(22) Filed: Mar. 17, 2023

(51) Int. Cl. G06N 5/043; G06N 5/022

(52) U.S. Cl. CPC G06N 5/043; G06N 5/022

(57) ABSTRACT

A method that includes obtaining, from a user through an interactive chatbot, data for one or more change documents, wherein the data is parsed and validated by a data validator of the chatbot and the one or more change documents are dynamically updated as data is received. The method further includes determining, based on data for one or more change documents, one or more derived quantities and generating, with an artificial intelligence (AI) engine, a change management plan based on the derived quantities, wherein the change management plan comprises a schedule. The method further includes transmitting one or more learning resources to the user based on the change management plan, tracking an implementation of the change management plan, and generating an alarm when the implementation of the change management plan does not align with the schedule.

### BACKGROUND

Globally, organizations and their business users have varying degrees of access to expertise and knowledge to manage operational and strategic initiatives. Often this information is scattered and lacks a holistic perspective.

To plan and execute transformation programs successfully, internal knowledge banks and expertise such as, project deliverables, lessons learned across multiple organizations, and supporting resource items need to be collected regularly and made available to business users through, at least, a search and retrieval system.

A major concern with knowledge collection and intelligent retrieval is that there is an ever-increasing complexity of variables and volume of data that feed management and executive decision making. The complexity and volume of data used for change management decisions is further enhanced when considering the financial cost, or benefits, and effects on business operations when implementing a transformation program.

Accordingly, there exists a need for an intelligent system that can efficiently access complex knowledge banks and generate a comprehensive change management plan that is tailored to the needs and roles of an organization and/or user.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method that includes obtaining, from a user through an interactive chatbot, data for one or more change documents, wherein the data is parsed and validated by a data validator of the chatbot and the one or more change documents are dynamically updated as data is received. The method further includes determining, based on data for one or more change documents, one or more derived quantities and generating, with an artificial intelligence (AI) engine, a change management plan based on the derived quantities, wherein the change management plan includes a schedule. The method further includes transmitting one or more learning resources to the user based on the change management plan, tracking an implementation of the change management plan, and generating an alarm when the implementation of the change management plan does not align with the schedule.

Embodiments disclosed herein generally relate to a management consultant digital assistant system. The management consultant digital assistant system includes a user interface and a chatbot, wherein the chatbot is configured to receive and transmit data from a user through the user interface. The management consultant digital assistant system further includes a data layer, wherein the data layer includes one or more change documents, wherein the change documents are dynamically populated by the user through interaction with the user interface and chatbot. The management consultant digital assistant system further includes a knowledge database and an artificial intelligence (AI) engine that implements one or more AI algorithms, wherein the AI engine processes the change documents of the data layer and the knowledge database to generate a change management plan that includes a schedule. The management consultant digital assistant system further includes a monitoring system, wherein the monitoring system tracks one or more key performance indicators (KPIs) during an implementation of the change management plan.

Embodiments disclosed herein generally relate to a non-transitory computer-readable memory that includes computer-executable instructions stored thereon that, when executed on a processor, cause the processor to perform the following steps: obtaining, from a user through an interactive chatbot, data for one or more change documents, wherein the data is parsed and validated by a data validator of the chatbot and the one or more change documents are dynamically updated as data is received; determining, based on data for one or more change documents, one or more derived quantities; generating, with an artificial intelligence engine, a change management plan based on the derived quantities, wherein the change management plan includes a schedule; transmitting one or more learning resources to the user based on the change management plan; tracking an implementation of the change management plan; and generating an alarm if the implementation of the change management plan does not align with the schedule.

Other aspects and advantages of the claimed subject matter will be apparent from the following description and the appended claims.

### BRIEF DESCRIPTION OF DRAWINGS

FIG. 1 depicts a change management lifecycle, in accordance with one or more embodiments.

FIG. 2 depicts a management consultant digital assistant system in accordance with one or more embodiments.

FIG. 3 depicts an example graphical user interface in accordance with one or more embodiments.

FIG. 4 depicts a system in accordance with one or more embodiments.

FIG. 5 depicts a change profile form in accordance with one or more embodiments.

FIG. 6 depicts a chatbot dialog box and form interaction in accordance with one or more embodiments.

FIG. 7 depicts an organizational readiness assessment form in accordance with one or more embodiments.

FIG. 8 depicts a change risk profile in accordance with one or more embodiments.

FIG. 9 depicts an impact assessment form in accordance with one or more embodiments.

FIG. 10 depicts a neural network in accordance with one or more embodiments.

FIG. 11 depicts a schedule in accordance with one or more embodiments.

FIG. 12A depicts an example key performance indicator (KPI) plot in accordance with one or more embodiments.

FIG. 12B depicts example tabular data metrics in accordance with one or more embodiments.

FIG. 13 depicts a flowchart in accordance with one or more embodiments.

FIG. 14 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “acoustic signal” includes reference to one or more of such acoustic signals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

In one aspect, embodiments disclosed herein relate to a management consulting digital assistant system that intelligently and interactively queries a desired organizational transformation from one or more users and provides the organization and its users with a tailored change management plan. The change management plan includes a schedule that outlines activities to be performed to implement the desired organization transformation along with a timeframe for performing the activities. The management consulting digital assistant system can further provide the organization and its users with various transformational change deliverables associated with the tailored change management plan. Transformational change deliverables may include, but are not limited to: risk assessment(s); communication plan(s); training plan(s); and key performance indicator (KPI) predictions. Examples of one or more transformational change deliverables are described later in the instant disclosure. The management consulting digital assistant system provides full-time support, training resources, and implementation tracking throughout the lifecycle of an organizational transformation. Implementation tracking consist of, at least, monitoring key performance indicators (KPIs), determining the root cause of an issue when a KPI is not met, and generating alarms and reports to the main users of the management consulting digital assistant. The management consulting digital assistant can adapt, in real-time, to changes in user goals and sentiment. The management consulting digital assistant can further interact with a community of subject matter experts (SMEs) to iteratively update and enhance the change management plan developed by the management consulting digital assistant. The interaction with SMEs through the management consulting digital assistant system allows for external and internal SMEs (or SME teams) to provide quality assurance (QA) on the change management plan and any associated transformational change deliverables. SMEs are also able to share best practices regarding organizational transformations. Because SMEs are able to both monitor and update ongoing organizational transformations, the management consulting digital assistant system enables two-way learning between the community of SMEs and the organization and its users undergoing a desired organizational transformation.

Organizations of any size may desire or be required to undergo an organizational transformation. Broadly defined, an organizational transformation includes any change that affects the operation, processes, organizational structure, systems, environment (physical or cultural), members, or product of an organization. Many categories of organizational transformations exist, such as, but not limited to: culture change; adoption of new business and/or software systems; mergers and acquisitions; adoption of new operational processes; changes in leadership, policies, standards, performance measures and incremental improvement initiatives.

Generally, organizational transformations should be implemented according to a plan and/or paradigm to efficiently guide and direct processes associated with a transformation to achieve a desired outcome. However, no universal plan and/or paradigm exists. In many instances, organizations employ some form of knowledge repository. A knowledge repository provides storage of information, such as case studies and historical data, for an organization and/or company. A knowledge repository may further include historical data, case studies, and various business analyses for other organizations. Generally, to enact an organizational transformation, one or more personnel may search a knowledge repository accessible by their organization to identify relevant transformation procedures. Knowledge repositories may be cumbersome such that identification of useful transformation procedures is a laborious and manual task. In short, a knowledge repository collects the knowledge of one or more organizations and, when harnessed, can lead to increased operational efficiencies. Knowledge repositories are becoming increasingly large and complex. When relevant knowledge cannot be readily identified and retrieved within an organization, it induces business costs as valuable time is spent seeking out the desired information.

Typically, the most effective organizational transformation plans and/or paradigms are those that are tailored to the unique needs and circumstances of the affected organization. Decisions regarding creating an organizational transformation plan are often coupled with external factors, such as other organizations and business partners, and can impact finances of one or more interconnected organizations. Thus, creating an effective organizational transformation often requires a complex comparative analysis, access to relevant portions of a knowledge repository, and interaction with subject matter experts.

The management consulting digital assistant system overcomes the aforementioned challenges by intelligently identifying a desired operational change, determining a change profile based on the makeup of the affected organization, retrieving relevant information from a knowledge repository, generating a change management plan, and monitoring and updating the change management plan as it is implemented according to real-time factors. The management consulting digital assistant system provides full-time support and unbiased decision making to an organization undergoing an organizational transformation throughout the life cycle of the transformation. As will be described, the management consulting digital assistant system includes an artificial intelligence (AI) engine that produces tailored organizational transformation procedures based on real data and proven approaches contained in a knowledge database. Consequently, the management consulting digital assistant system aids in lowering the risk associated with management decisions by removing human bias (e.g., decisions made based on emotional factors such as anxiety). Further, the full-time support provided by the management consulting digital assistant system reduces human intervention and associated delays.

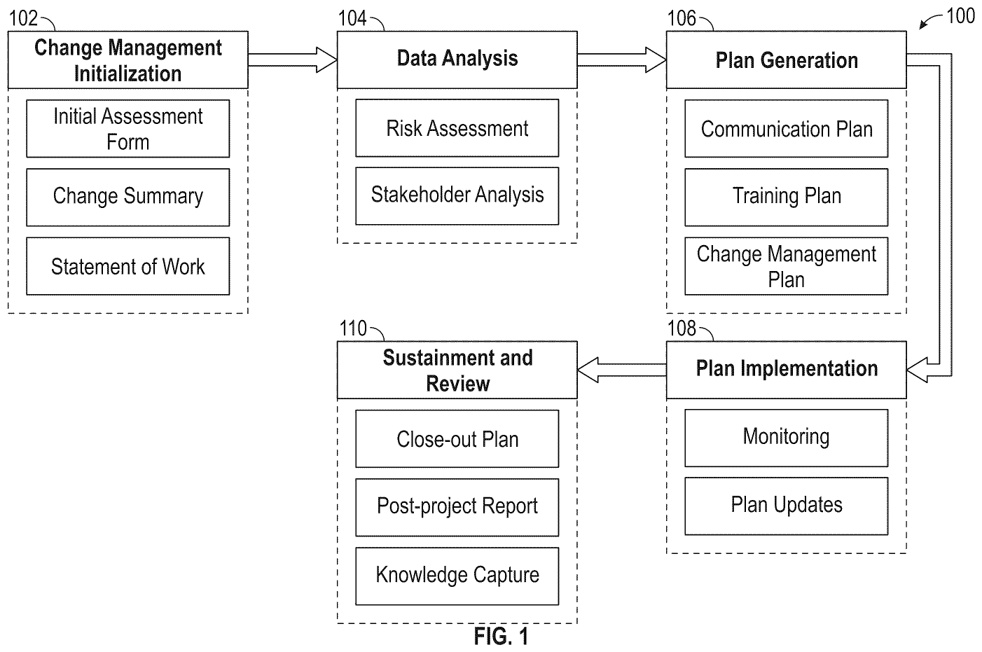

FIG. 1 depicts a generalized lifecycle of an organizational transformation, in accordance with one or more embodiments. The organizational transformation lifecycle (100) begins with change management initialization (102). The change management initialization (102) process seeks to identify the desired (or required) organizational transformation and outline the transformation objectives. The change management initialization (102) process may include using an initial assessment form to categorize the transformation and identify affected parties. Products of the change management initialization (102) may include a change summary and a statement of work. A change summary summarizes information about the organizational transformation obtained from the initial assessment form. The statement of work standardizes, formalizes, and documents the scope of the organizational change.

Upon completion of the change management initialization (102) processes, the organizational transformation lifecycle (100) may include further data analysis (104). The data analysis (104) step may include a risk assessment and a stakeholder analysis. The risk assessment seeks to determine the risk incurred by the organizational transformation identified during change management initialization (102). Risk assessments may be quantitative or qualitative in nature. The risk assessment further identifies the consequences of failed transformation objectives. The stakeholder analysis determines the individuals affected by the organizational transformation, their roles, and their influence on the organizational transformation. The stakeholder analysis further identifies any barriers or pain points that may be presented by individuals affected by, or otherwise participating in, the organizational transformation.

With proper data analysis, a transformation plan may be generated. The plan generation (106) step involves the creation of one or more plans, which may be categorized according to type, that should be implemented to realize the organizational transformation. Types of plans may include a communication plan, a training plan, and a change management plan. The communication plan indicates the flow of information between stakeholders. For example, a communication plan may indicate that a management team needs to have a face-to-face discussion with a technology team to identify perceived challenges associated with the adoption of a new information technology software. The training plan maps learning resources to stakeholders. Finally, the change management plan outlines all the steps required to realize the organizational transformation, including items listed in the communication plan, training plan, and other plans, and lists any planned deliverables. That is, a change management plan may consist of various plans and deliverables related to plans of various types for transformations across any industry or business domain.

With a change management plan in place, the plan must be implemented. The plan implementation step (108) involves monitoring the implementation. For example, monitoring activities may include tracking that planned deliverables and training programs are completed on time in accordance with the change management plan. Further, the plan implementation (108) includes updating the plan as required due to missed deadlines (as identified through monitoring), changes in the desired transformation, or other environmental or external factors.

Finally, the organizational change lifecycle (100) ends with a sustainment and review process (110). Sustainment involves the creation of a plan (e.g., close-out plan), or other checks, to ensure that the realized organizational transformation persists. This step further includes producing a post-project report that describes the success, in quantitative or qualitative terms, of the change management plan. The post-project report, and other information collected during the organizational transformation are captured and stored in a knowledge repository for access and analysis at a later date.

It is noted that the organizational transformation lifecycle (100) depicted in FIG. 1 is given only as an example. One with ordinary skill in the art will recognize that many alterations to the steps depicted in FIG. 1, and their processes and products, exist and that the organizational transformation lifecycle (100) is not intended to be universal nor impose a limitation on the instant disclosure.

As will be described herein, the management consultant digital assistant system disclosed herein encompasses and supports all the steps and processes associated with the organizational transformation lifecycle (100). As will be described, the management consultant digital assistant further enhances aspects of an organization transformation throughout its lifecycle by providing, among other things: a “one-stop” user interface integrated with an interactive and intelligent chatbot; training and coaching resources; user skills assessments and certifications; SME community support; and a change management plan that includes a schedule.

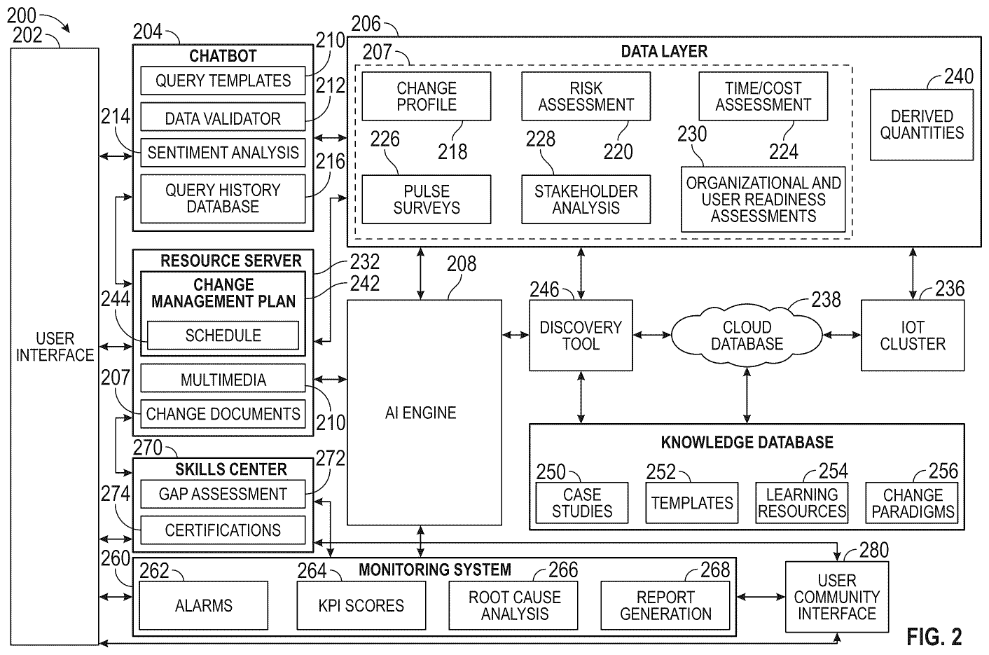

FIG. 2 depicts the management consultant digital assistant system (200) in accordance with one or more embodiments. In FIG. 2, the management consultant digital assistant system (200) is depicted as being comprised of various components and/or modules, where the components and/or modules may interact with each other. One with ordinary skill in the art will recognize that the partitioning, organization, and interaction of the components and/or modules of the management consultant digital assistant system (200) in FIG. 2 is intended to promote clear discussion and should not be considered fixed or limiting. For example, FIG. 2 depicts a chatbot (204) as an independent entity, however, it is well understood that in practice the chatbot (204) may be implemented as part of the user interface (e.g., through a “front end” coding effort) or part of the artificial intelligence (AI) engine (208) (e.g., through a “back end” coding effort).

As depicted in FIG. 2, the management consultant digital assistant system (200) includes a user interface (202). In one or more embodiments, the user interface (202) is a graphical user interface. The user interface (202) acts as the point of human-computer interaction and communication. Thus, the user interface (202) can receive inputs from a user. Through the user interface (202), a user may upload forms. The user interface (202) further provides visualizations, such as graphs, reports, and text and image data, to one or more users. In broad terms, the user interface (202) can include display screens, keyboards, and a computer mouse. In one or more embodiments, the user interface (202) is implemented as a computer program, such as a native application or a web application. It is also the way through which a user interacts with an application or a website.

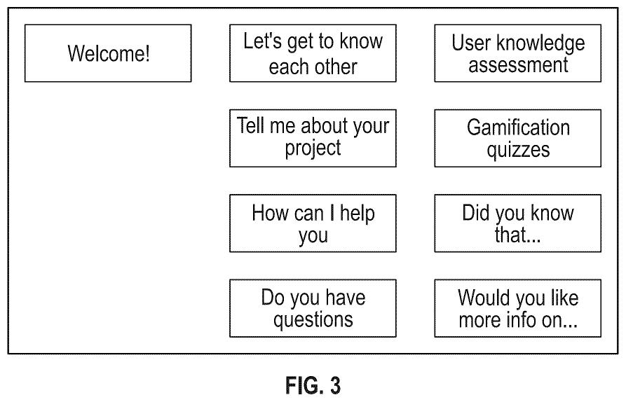

FIG. 3 depicts an example graphical user interface provided by the user interface (202), in accordance with one or more embodiments. As seen, in one or more embodiments, the example graphical user interface provides a menu with one or more buttons that direct users to specific resources, content, and/or other menus. The user interface (202) provides a convenient and user-friendly mechanism to access and organize the products of the management consultant digital assistant system (200) at any point during the lifecycle of an organizational transformation.

An organizational transformation effort can affect a group of users. For example, and organizational transformation may be initiated by management personnel and affect the systems, culture, and/or processes of various persons in the organization. In one or more embodiments, for a give organizational transformation, the management consultant digital assistant system (200) can interact with any of the persons affected by the organizational transformation according to their specific role. Thus, the user interface (202) may present a tailored interface for the users. For example, accessibility to content encompasses by the management consultant digital assistant system (200) may be controlled through the user interface (202) and user-access rights. As such, each user can interact with the management consultant digital assistant system (200), simultaneously if needed, according to their specific needs but the management consultant digital assistant system (200) is still “globally” aware of the needs of a given organizational transformation.

Returning to FIG. 2, the management consultant digital assistant system (200) includes a chatbot (204). In one or more embodiments, the chatbot (202) can directly receive and parse text, image, and audio data (e.g., through a microphone as part of the user interface (202)). Using natural language processing (NLP), the chatbot (204) provides real voice to speech recognition in multiple languages. The chatbot (202), through the user interface (202) can scan in pictures (or other visual data) and use visual character and imaging software to interpret and create insights.

In accordance with one or more embodiments, input data is obtained from a user through interaction with the chatbot (204). For concision, a brief description of a chatbot and its interactions with a user are provided herein. However, one with ordinary skill in the art will recognize that a chatbot may be implemented in a variety of ways such that the following description does not impose a limitation on the present disclosure. The input data obtained by the chatbot is composed of one or more input values. Often, input values are associated with a data type and range or set of acceptable values. For example, a given input value may be specified to represent a numeric value for a month, in which case the input value data type may be restricted to an integer data type and the acceptable range of the input value is set to the numbers 1 through 12.

In general, a chatbot has access to one or more queries, where each query is associated with one or more input values of the input data. In one or more embodiments, the relationship of queries and associated input values are defined by a set of query templates (210). The chatbot (204) identifies an input value that should be received from the user and prompts the user with an appropriate query. The user responds to the a query with a response. The chatbot analyses the response and determines whether the desired input value(s) is contained in the response and further validates the input value(s) with a data validator (212). That is, the chatbot (204) both identifies a candidate input value in the response of the user and determines if the candidate input value is valid based on the pre-defined data type and set of acceptable values, if provided in the set of query templates (210). In many instances, the data validator (212) used by the chatbot is configured with one or more data preprocessing and parsing algorithms (e.g., stemming, regular expressions, etc.) and/or natural language processing (NLP) models to properly handle text variations (e.g., capitalization), provide common mappings (e.g., month abbreviations to numeric values), and allow for data type coercion (e.g., floats to integers).

Based on the analysis of a response, the chatbot (204) can accept the input value or re-prompt the user. If the chatbot (204) determines that a user should be re-prompted for an input value, the chatbot (204) may re-use the query or propose a new query and/or provide aid or suggestions to the user, for example, detailing why the original response and input value(s) were not accepted. If an input value(s) is accepted by the chatbot (204), the chatbot (204) may provide the user with another query to obtain other input values. Note, that in some instances, subsequent queries selected by the chatbot (204) are determined based on previously received input values. The chatbot (204) may continue prompting the user with selected queries until the required input data has been received. The scope of the required input data may be altered according to the input value(s) received from the user. That is, based on received input value(s) the chatbot (204) may determine that other input values are no longer required and thus not prompt the user with the associated queries. Again, it is emphasized that the above description of a chatbot does not impose a limitation on the instant disclosure as various types of chatbots may be readily inserted into the framework disclosed herein.

In accordance with one or more embodiments, the chatbot (204), through interactions with users, is configured to intelligently adapt its queries to enhance the experience of the user. The chatbot (204) is not restricted to a pre-defined set of queries. The chatbot evaluates its interactions with users and based on the evaluation, can select different queries, alter existing queries, and/or generate queries to more efficiently extract desired information (input values) from its users while simultaneously enhancing user experience.

In one or more embodiments, the chatbot (204) is configured with multiple candidate queries for each input value. To obtain an input value from a user, the chatbot (204) selects one of the associated candidate queries. The selection may be performed randomly or according to a pre-configured probability distribution. In one or more embodiments, upon receiving a response from a user, the chatbot (204) determines a sentiment of the response through sentiment analysis (214). Broadly defined, sentiment analysis (214) consists of capturing the emotions and/or feelings of a user by evaluating the user responses and/or inputs, where user input data may be formatted as text, image, and/or audio. In one or more embodiments, the sentiment analysis (214) functionality is integrated directly with the chatbot (204). In other embodiments, the sentiment analysis functionality is provided through a module and/or computer program/system external to the chatbot (204). In these instances, the chatbot (204) may interact with the sentiment analysis (214) program/system through an application programmer interface (API) or other data exchange system. More information regarding the sentiment analysis (214) will be provided later in the instant disclosure. In one or more embodiments, the chatbot (204) determines changes in user sentiment when responding to a query and determines the success of the query. The detected user sentiment, change in user sentiment, and success indicator for the query are stored in a query history database (216). Like unto the sentiment analysis (214) program/system, the query history database (216) may be directly integrated into the chatbot (204) or considered a separate system that may exchange data with the chatbot (204). Over multiple user-chatbot interactions, a success ratio and aggregate sentiment score can be determined for each of the candidate queries using the query history database (216).

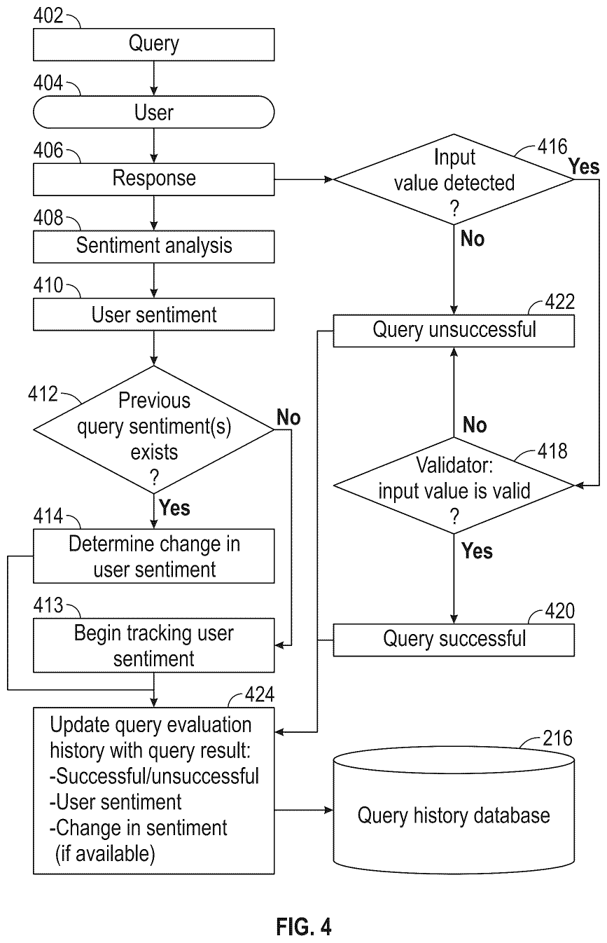

In accordance with one or more embodiments, FIG. 4 depicts the process of determining the success and associated sentiment of a query and storing the result in the query history database (216). As seen in FIG. 4, in Block 402, to receive a desired input value(s) a query is provided to a user (Block 404). The user responds with a response, depicted in Block 406. In Block 408, the response is processed by a sentiment analysis algorithm (214). Any sentiment analysis algorithm (214) known in the art may be employed, including, but not limited to: context aware deep learning models (e.g., LSTM, transformers); lexicon-based models; and supervised or unsupervised machine learning models. The sentiment analysis algorithm (214) outputs a user sentiment, depicted by Block 410. The user sentiment is stored for later use. Block 412 checks if the query of Block 402 is the first query received by the user or if previous queries were presented. If the given query is not the first query received by the user during a given user-chatbot session, in Block 414, the user sentiment for the given query is compared to the previous user sentiment(s) of the user during the user-chatbot session to determine if the given query resulted in a change in user sentiment. For example, given an initial query, the user sentiment may reveal that the user is confused or anxious. However, with subsequent interactions with the chatbot (i.e., queries and responses), the user sentiment may reveal that the user is optimistic or enthusiastic. In this example, changes in the user sentiment would be considered positive. Additionally, and as seen in FIG. 4, in Block 416, the response is evaluated to determine if an input value is detected. If an input value is detected the input value is processed by the data validator (210) to determine if the input value is valid. The validity of the input value is checked in Block 418. If the input value is determined to be valid, then the query is considered successful and the process of FIG. 4 proceeds to Block 420 while noting the success of the query. If either the input value is not determined to be valid (Block 418) or an input value is not detected (Block 416), the query is considered unsuccessful. Block 422 depicts the status of the query as unsuccessful. In the case of an unsuccessful query, the user will need to be prompted again (using the same or different query) in order to receive the desired input value(s). Returning to Block 412, if the query is determined to be the first received by the user, no change in sentiment can be detected. In this case, as depicted in Block 413, tracking of user sentiment is initiated. In Block 424, the status, successful or unsuccessful, user sentiment, and change in user sentiment (if available) are stored in the query history database (216).

After multiple user-chatbot sessions, the query history database (216) is used to evaluate each of the candidate queries described by the query templates (210). For each candidate query, a success ratio is calculated, where the success ratio is the ratio of number of times the query was successful over the number of times the query was used. Further, user sentiments and changes in user sentiment can be used to determine an aggregate sentiment score for each candidate query. In one or more embodiments, the success ratio and aggregate sentiment score are compared to a ratio threshold and a sentiment threshold, respectively. The ratio threshold and sentiment threshold are pre-configured chatbot (204) parameters. Queries with a success ratio or an aggregate sentiment score below the ratio threshold and sentiment threshold are flagged for manual inspection and possibly removal by a chatbot engineer. As an example, consider simple yet relatable query, where the intent of the query is to learn the birthday of a user. The query “input birthdate in MM/DD/YYYY format (with no other text)” may have a high success ratio but a poor aggregate sentiment score. Upon being flagged, the chatbot engineer can adapt this query. This process ensures that the chatbot effectively extracts desired information from its users while enhancing user experience.

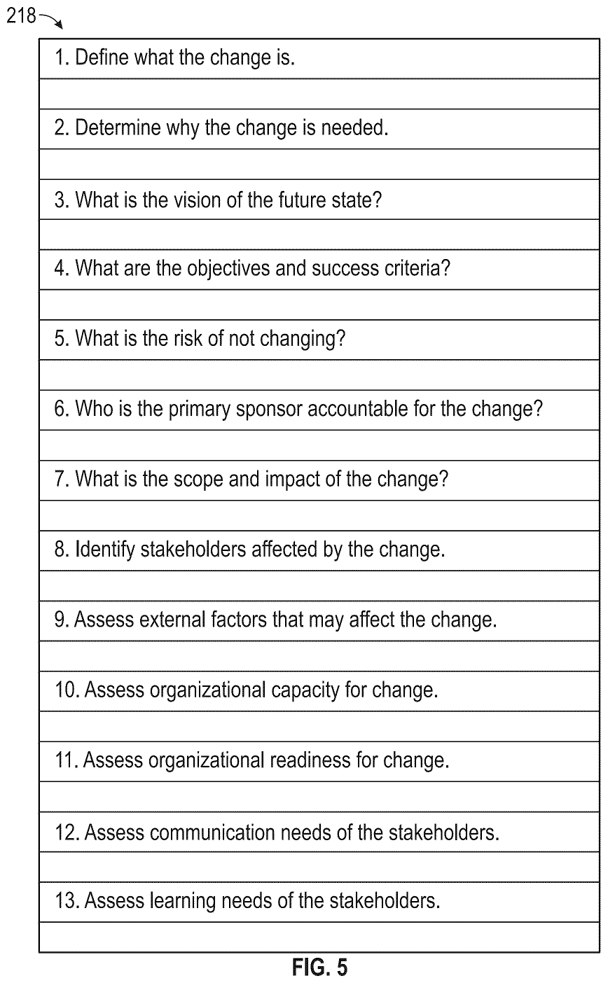

In other embodiments, candidate queries are served to users according to an adaptive probability distribution without the need for inspection and alteration by a chatbot engineer. Herein, a chatbot engineer may refer to any support personnel where support personnel are responsible for the technological implementation of the management consultant digital assistant system (200). In one or more embodiments, the probability distribution is adapted based on the success ratio and aggregate sentiment score according to Bayesian network. In one or more embodiments, the chatbot (204) is coupled with an adaptive language model and/or generative language model. The language model(s) may receive a candidate query that seeks to obtain a prescribed set of input values from a user and adapt or re-write the query. Queries used in user prompts are evaluated to determine their efficacy and their effect on user experience. The evaluation of queries guides future adaptations to queries (or generated queries). Returning to FIG. 2, in one or more embodiments, the management consultant digital assistant system (200) further includes a data layer (206). In general, the data layer consists of one or more change documents (207) or change templates. The change documents (207) may include, but are not limited to: a change profile (218); a risk assessment (220); a time and cost assessment (224); one or more pulse surveys (226); a stakeholder analysis (228); and organizational and user readiness assessments (230). In general, change documents (207) encompassed by the data layer (206) organize data that details and quantifies aspects of the organizational transformation. FIG. 5 depicts an example change profile (218) document. The change profile (218) document consists of various questions that may be asked to a user initiating an organizational transformation. The questions of the change profile (218) seek to identify the type and scope of the desired organizational transformation (e.g., merger and acquisition, culture, system adoption, etc.).

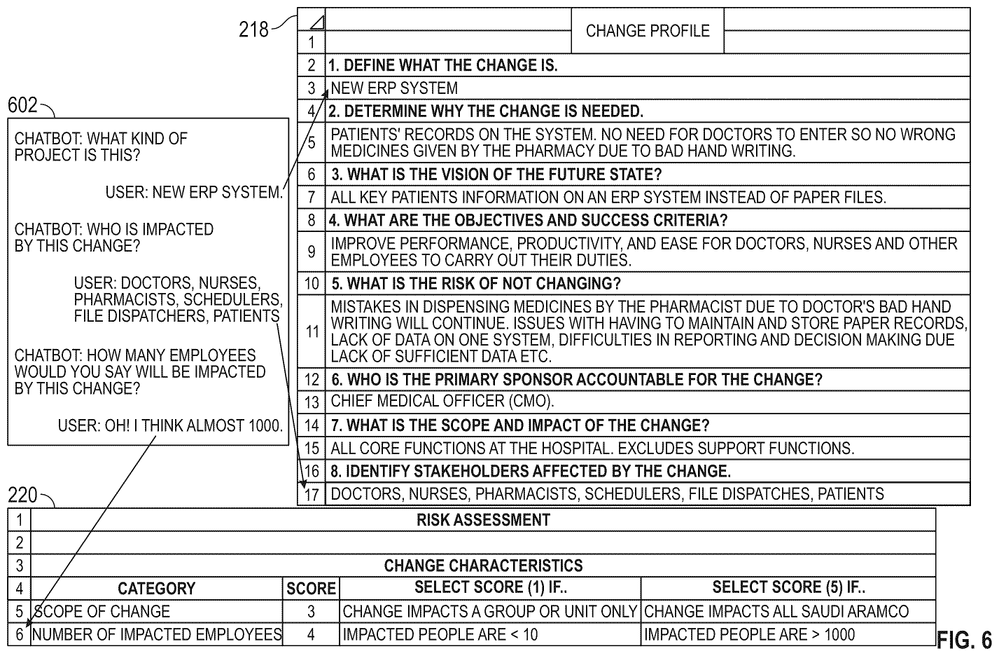

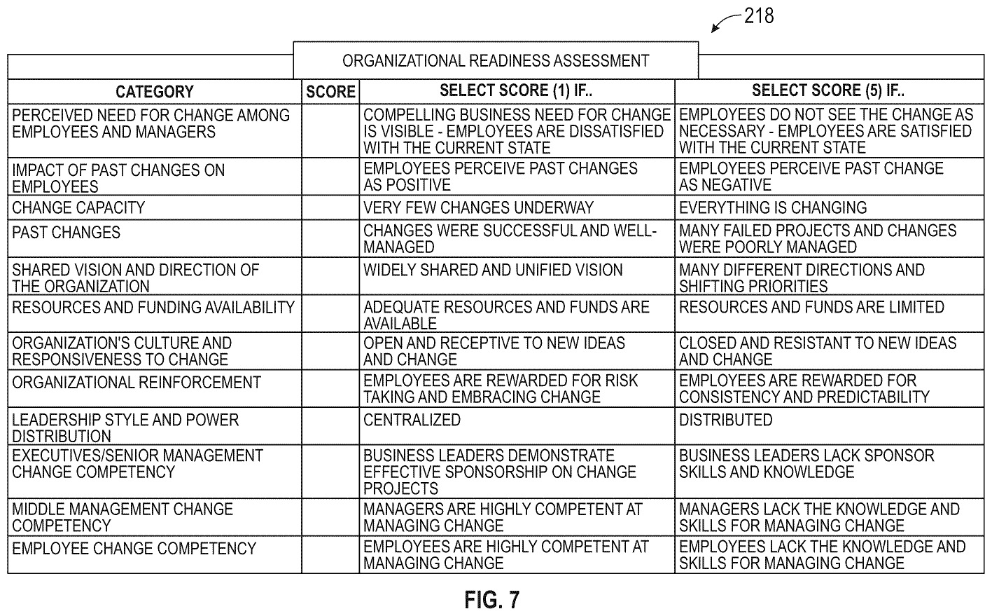

In accordance with one or more embodiments, responses to the questions listed in the change profile (218), and other change documents (207) included in the data layer (206), are received from a user through interaction with the chatbot (204). FIG. 6 depicts a chatbot dialogue box (602). The chatbot dialogue box (602) is displayed to the user through user interface (202) and allows the user to interact with the chatbot (204) by receiving and responding to queries. As seen in FIG. 6, responses provided by the user to chatbot queries are used to populate change documents (207) in the data layer (206), such as the change profile (218) and the risk assessment (220). In many instances, the change documents (207) of the data layer (206) are forms or questionnaires. In instances where the change documents (207) are populated by the chatbot (204), the user may not realize that they are filling out a change document.

The management consultant digital assistant system (200) is configured, through use of the chatbot (204), query templates (210), and the change documents (207) to intelligently receive data from the user. As data is received from the user, change documents (207) may be altered and/or omitted according to user needs. For example, questions that are only relevant to organizations with fewer than 500 members will not be presented to the user if the number of persons impacted by a desired organizational transformation exceeds 500. In one or more embodiments, for example, in cases where a change document (207) is complex, the change document (207) may be served to the user via a resource sever (232). The resource server (232) packages documents, reports, and other data entities, as needed, and serves one or more resources to the user. Depending on the type of resource, the resource server (232) may make the resource available for display through the user interface (202), may provide a download link, and/or may transmit the resource to another multimedia device of the user (e.g., SMS text message to mobile device, email to user domain server, etc.). In one or more embodiments, the resource server (232) automatically distributes reports, reminders (or other resources) to designated users. The distribution or resources may be according to a pre-defined schedule and/or triggers. For example, an alarm (262), to be described below, may act as a trigger that initiates the resource server (232) to transmit a resource (e.g., through email). In one or more embodiments, the resource server (232) may also automatically fill in forms or other data in the data layer (206) and the knowledge database (248), described below, in order to capture and store reports and historical data surrounding the organizational transformation under implementation. As such, in one or more embodiments, the resource server (232), in coordination with the chatbot (204), serves a change document (207) to the user and requests that the user populate the change document (207). For example, through the chat dialogue box (602), the chatbot (204) may request that the user fill out a change document (e.g., pulse survey) and provide a download link served by the resource server (232). The management consultant digital assistant system (200) pre-populates any change document (207) provided to the user with pre-populated values previously received and parsed by the chatbot (204), if applicable. As such, change documents (207) received by the user are tailored to user needs and the type of organizational transformation. Upon filling out a change document (207), the user may submit the change document (207) to the management consultant digital assistant system (200) via the chatbot (204). In instances where the change document (207) was populated digitally by the user, the chatbot (204), through the data validator (212), parses the change document and can query the user for missing and/or invalid information before storing the completed change document (207) in the data layer (206). In instances where the user completes a change document “by hand,” the management consultant digital assistant system (200) may use optical character recognition (OCR) to digitize the document before parsing and validation. In other embodiments, the user may respond to or complete a change document (207) through an SMS text message or email response. As such, the management consultant digital assistant system (200) can accept data and information from a user in a wide variety of formats, including but not limited to: PDF documents, word documents, hand-written documents, HTML, email, and SMS text messages. Beyond OCR, the management consultant digital assistant system (200) processes images and reports (either received or contained in the knowledge database (248) described below) with visual recognition software to parse and detect relevant content and insights.

Continuing with the data layer (206), the risk assessment form (220) provides a framework, through questions, to quantify the risk incurred through an organizational transformation. In one or more embodiments, the risk assessment form (220) further identifies potential roadblocks or pain points associated with a desired organizational transformation according to the desired change and characteristics of the affected organization. The time/cost assessment (224) estimates the expected time for a transformation to occur and identifies any time constraints that may be imposed by a user. Further, the time/cost assessment (224) estimates the monetary cost associated with implementing the desired organizational transformation. Pulse surveys (226) are short surveys given to one or more users of the affected organization. Typically, pulse surveys (226) consist of a brief and regular set of questions and are administrated periodically throughout the lifecycle of an organizational transformation. As such, pulse surveys (226) may be evaluated over time to identify changes in user viewpoints and sentiment. A stakeholder analysis (228) characterizes the personnel of an organization. The stakeholder analysis (228) identifies the number of persons in an organization, their roles, and quantifies the level of impact that an organizational transformation will have on each person.

The organizational and user readiness assessments (230) aid in determining, quantitatively and/or qualitatively, the readiness of an organization and its users to embark on and implement an indicated desired organizational transformation. Failing to assess an organization's readiness is one of the biggest errors leaders can make when embarking on a major change effort. As a result, leaders risk imposing an organizational transformation on an organization that is unwilling or unable to adopt it. The organizational and user readiness assessments (230) measure, among other things, the capacity of leadership to lead change, middle management capacity, the organization's past success with organizational transformations (if previously performed), urgency, impact, and purpose. The organizational and user readiness assessments (230) may track an organizational transformation score, indicating an organization's ability to accept an organizational transformation.

Further, assessing user readiness is critical as a new change in organizational structure, competitive landscape, or technology systems may require the workforce to respond swiftly by acquiring new behaviors and skills. The general way to assess user readiness though organizational and user readiness assessments (230) is through skill gap assessments (described in greater detail below in the instant disclosure), interview feedback, skill benchmarking, review of certificates, and review of workforce industry associations.

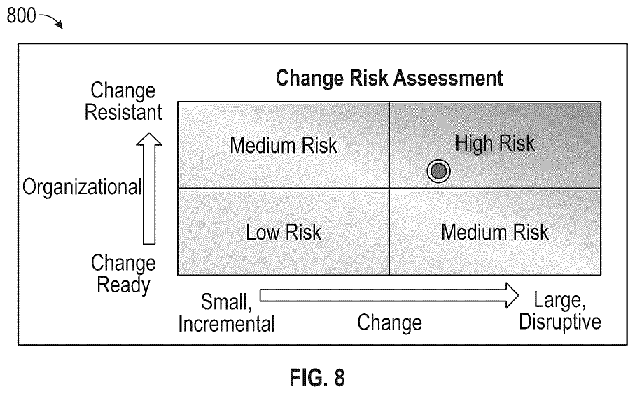

FIG. 8 depicts an example organizational readiness form (218) that may be promoted by the management consultant digital assistant system (200) to be filled out by a user initiating an organizational transformation. The organizational readiness form (218) seeks to score an organizations ability to accept an organizational transformation. As previously described, the organizational readiness form may be populated, as needed, by a user through the user interface (202).

For concision, an example of each change document (207) is not provided as a figure. However, one with ordinary skill in the art will recognize that the management consultant digital assistant system (200) identifies change documents (207) to be populated, pre-populates the change documents (207) where applicable, validates user responses, and stores completed change documents (207) in the data layer (206).

In accordance with one or more embodiments, the management consultant digital assistant system (200) further includes an internet of things (IoT) cluster (236). The IoT cluster (236) is a collective network of connected devices. The IoT cluster (236) provides a technology architecture that facilitates communication between its collective devices, the data layer (206) and, in some embodiments, a cloud database (238). The devices may include embedded sensors and/or edge devices contain by the organization undergoing and organizational transformation. Communication between IoT cluster (236) devices may be facilitated through RFID, NFC, low-energy Bluetooth, low-energy wireless, low-energy radio protocols, LTE-A, and WiFi-Direct technologies. As an example of the usefulness of collecting data from devices of an IoT cluster (236), consider the case where the desired organizational transformation consists of deploying a new software program for use across an organization. In this case, the IoT cluster (236) can be used to track which computers within the affected organization have had the new software installed. Thus, the IoT cluster (236) can be used to track the deployment rate in real time and further provide statistics regarding usage of the new software (i.e., an adoption rate). In other instances, devices within an IoT cluster (236) may include acoustic, tactile, optical, pressure, and temperature sensors used to connect machinery and equipment where any new system or process is being deployed. Further, where activities associated with an organizational transformation are associated with human action, IoT cluster (236) devices such as video feeds and motion sensors can be used to track these actions and acquire additional data.

In one or more embodiments, the data layer (206) further includes derived quantities (240). The derived quantities include scores developed from the information contained in the change documents (207). In most cases, the scores are calculated according to a set of rules and/or mathematical functions (i.e., “hard coding”). That is, the data layer (206) includes a set of instructions for transforming the data, which may be textual, of the change documents (207) to quantitative or qualitative indicators. In one or more embodiments, data received by the data layer (206) from the IoT cluster (236) is aggregated and/or combined with change document (207) data to form one or more derived quantities which may be continuous-valued or categorical. In one or more embodiments, the data layer (206) contains a computer processor (not shown in FIG. 2) and or computer-readable memory (not shown in FIG. 2) to calculate the derived quantities (240) from the received and stored data. As an example, FIG. 8 depicts a two-dimensional change risk assessment (800) quadrature chart. The change risk assessment (800) provides a risk value along two dimensions; namely, a dimension that measures an organization's resistance (or readiness) to accept and apply the desired organizational transformation, and a dimension that measures the complexity of the desired change. The “measurements” along these two dimensions are derived quantities (240) that have been computed according to a set of rules and/or functions from information contained in completed change documents (207). The change risk assessment (800) quadrature chart may be served by the resource server (232) and displayed to a user through the user interface (202).

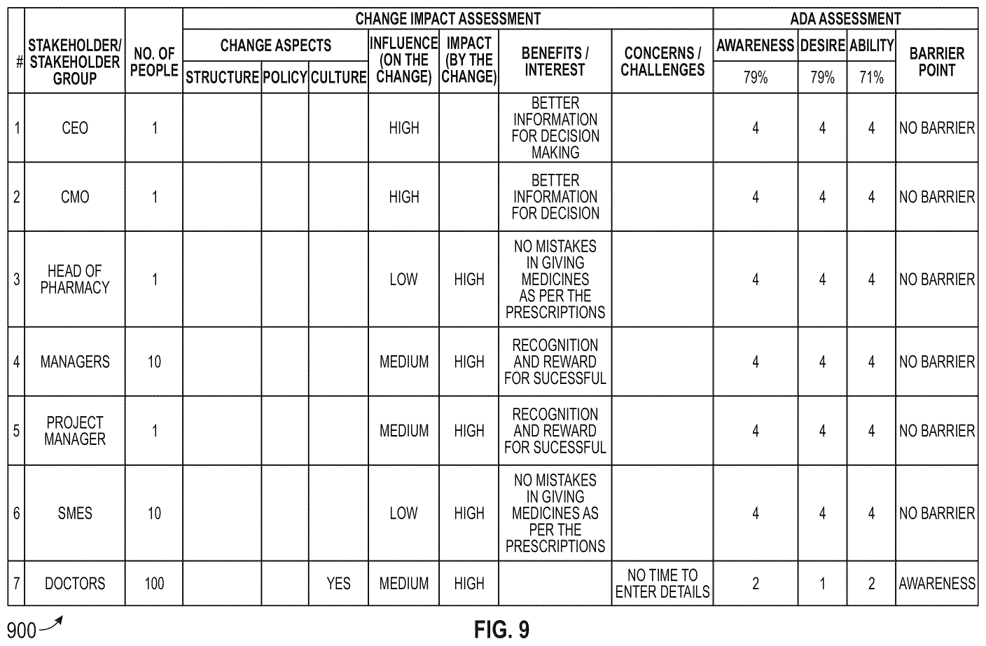

As an additional example, FIG. 9 depicts an impact assessment (900) that quantifies, among other things, the degree of impact the desired organizational transformation will have on various stakeholders. The impact assessment (900) further categorizes whether or not a barrier (or change resistance mechanism) exists for each stakeholder group. In the impact assessment (900) example of FIG. 9, a barrier can be categorized as any combination of “awareness,” “desire,” and “ability,” or “no barrier.” In short, the derived quantities (240) are a numerical representation and/or characterization of the desired organizational transformation and the affected organization. As will be described in greater detail below, in one or more embodiments, the derived quantities (240) are processed by an artificial intelligence (AI) engine (208) to produce a bespoke change management plan (242). Further, in one or more embodiments, the derived quantities (240) are used with a discovery tool (246) for search and comparison with historical items and documents contained within a knowledge database (248).

In accordance with one or more embodiments, the management consultant digital assistant system (200) further includes a knowledge database (248). The knowledge database (248) acts as a repository for various documents. The documents contained by the knowledge database (248) are organized according to a taxonomy. For example, documents may be grouped according to the type of organizational transformation (e.g., cultural, system adoption, acquisition, etc.). In one or more embodiments, the knowledge database contains data, change documents (207), and change management plans (242) from historical (previously implemented) organizational transformations. Historical organizational transformation data may come from post-project reports, and other information collected during an organizational transformation. In one or more embodiments, historical organizational transformation data, which includes the events and/or actions that occurred during previous organizational transformations, are weighted according to their success by one or more subject matter experts (SMEs). Further, the historical data are annotated with the rationale for the designation (e.g., success or failure) and/or ranking assigned to an activity or organizational transformation as a whole by the SMEs. Thus, the AI engine (208) can leverage the historical data for predictions and inferences regarding current and future organizational transformations managed with the management consultant digital assistant system (200).

Historical organizational transformations may further be annotated with metadata indicating the success of a historical transformation, hindsight analysis regarding the usefulness of activities performed during an organizational transformation, and lessons learned. In one or more embodiments, the metadata surrounding historical organizational transformations is referred to as case studies (250). In one or more embodiments, the knowledge database further includes learning resources (254). Learning resources (254) include instructional programs, such as video series, manuals, and textbooks for various organizational transformation activities. Finally, the knowledge database (248) includes change paradigms (256). In the realm of business management, several change paradigms (256) have been created and popularized. For example, a common change paradigm (256) is the Awareness-Desire-Knowledge-Ability-Reinforcement (ADKAR) paradigm. Thus, the knowledge database (248) contains, at least, a description of each change paradigm (256) so that a user, when appropriate, may learn about an select a paradigm to follow. The knowledge database further includes templates (252). The templates outline the processes associated with organizational transformation activities and/or change paradigms (256). In one or more embodiments, items contained by the knowledge database (248) are tagged to aid in search and comparison functions. The management consultant digital assistant system (200) tracks the frequency that items (e.g., templates (252), change paradigms (256), etc.) in the knowledge database (248) are accessed. Thus, the management consultant digital assistant system (200) can flag unused (or relatively underused) items for manual inspection by a subject matter expert (SME) to determine if the item is relevant, requires an update, and/or is tagged correctly. Further, in one or more embodiments, the management consultant digital assistant system (200) identifies popular and/or trending items and can highlight said items through an announcement distributed to one or more users by the resource server (232).

In accordance with one or more embodiments, the management consultant digital assistant system (200) includes, or at least can interact with, a cloud database (238). In one or more embodiments, the cloud database (238) provides interconnectivity for the IoT cluster (236) and other components/modules of the management consultant digital assistant system (200). In other embodiments, the cloud database (238) includes a secure connection to the internet (or other external network) with associated programming for searching and/or web scrapping functions. In these embodiments, the cloud database (238) can identify publicly available web resources and store relevant data entries for future look-up and use. For example, consider the case where a best practice of an organizational transformation involves making an announcement, or posting other data, on a social media website (e.g., Twitter, Facebook, etc.). Through the cloud database (238) the management consultant digital assistant system (200) can monitor such social media feeds to ensure and validate that these events and/or actions occurred according to the change management plan (232) of the management consultant digital assistant system (200). Note that both the change management plan (232) and monitoring capabilities of the management consultant digital assistant system (200) will be described in greater detail below. In one or more embodiments, the management consultant digital assistant system (200) monitors internal company databases and systems (e.g., email servers). Though the cloud database (238) scrapping and internal systems monitoring, the management consultant digital assistant system (200) can detect leakage of confidential information associated with an organizational transformation and notify one or more key users (e.g., upper level management personnel).

In accordance with one or more embodiments, the management consultant digital assistant system (200) includes a discovery tool (246). In one or more embodiments, the discovery tool (246) identifies useful material and documents contained withing the knowledge database (248) and in the cloud database (238) based on the information contained within the data layer (206) (i.e., the characterization of the desired organizational transformation and the affected organization). The discovery tool (246) is equipped with natural language processing (NLP) functionality. In one or more embodiments, a user may ask a question through the chatbot (204). In such situations, the management consultant digital assistant system (200) can search for and provide an answer to any user-based using rational and multiple matches. Further, the discover tool (246) can rate confidence of matching, and even highlight key query text to directly point the user to relevant information within a document identified in the cloud database (238) and/or the knowledge database (248). Relevant text highlighting may be applied across multiple resources as to provide meaningful cross-references and insights. Further, the discovery tool (246) can parse metadata of resources and further recognized text and information in custom fields such as subtitles, headers, table entries, and glossaries. In one or more embodiments, the discovery tool (246) produces a “smart document” that pinpoints and integrates relevant information from multiple sources. Additionally, the discover tool (246) can rank answers buried within documents using intelligent scoring algorithms. Upon ingestion and digestion of data from the cloud database (238) and the knowledge database (248) the discovery tool (246) adds NLP enrichments to data such as entity extractions and sentiment analysis. In accordance with one or more embodiments, the discovery tool (246) can learn, through machine learning and artificial intelligence-based methods, domain-specific terminology (e.g., case management language, industry jargon, etc.). In summary, the discovery tool (246) parses hundreds of documents in knowledge database (248) and the cloud database (238), extracting key words, groupings, speech entities, themes and concepts, and provides feedback for confidence of a good match. In one or more embodiments, high confidence matches are served to the user through the user interface (202). In some embodiments, the high confidence matches are intelligently combined into a single “smart document.”

In accordance with one or more embodiments, the management consultant digital assistant system (200) further includes an artificial intelligence (AI) engine (208). Artificial intelligence (AI), broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence will be adopted herein. However, one skilled in the art will recognize that the concepts and methods detailed hereafter are not limited by this choice of nomenclature.

In general, artificial intelligence (AI) encompasses a large body of algorithms, wherein the parameters of the algorithms are determined by evaluating a data set. AI algorithms are often categorized based on their intended function, the type and quantity of data they receive, and field of use. Common categorizations may include supervised learning, unsupervised learning, semi-supervised learning, and reinforcement learning. Additional categories, which are not exclusive the aforementioned categories, may include computer vision (CV) and natural language processing (NLP). In many instances, AI algorithms are further categorized as regressors or classifiers. The AI engine (208) of the instant disclosure may make use of any known AI algorithm known in the art and future algorithms. The AI engine (208) model types may include, but are not limited to, generalized linear models, Bayesian regression, random forests, and deep models such as neural networks, convolutional neural networks, transformers, and recurrent neural networks. AI model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding an AI model is referred to as selecting the model “architecture”. Once an AI model type and hyperparameters have been selected, the AI model is trained to perform a task. In accordance with one or more embodiments, one or more AI model types and associated architecture are selected and trained to perform specific tasks such as sentiment analysis and anomaly detection.

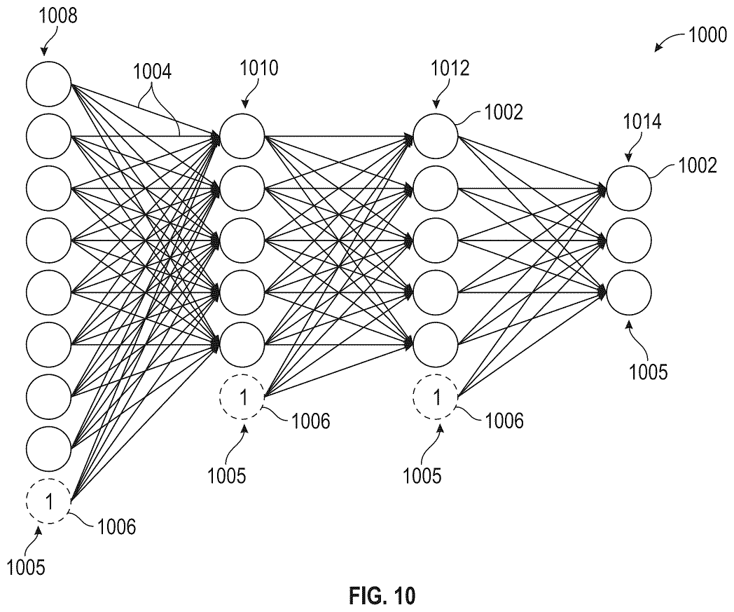

As an example of an AI model that may be included in the AI engine (208) and thus employed by the management consultant digital assistant system (200), FIG. 10 depicts a diagram of a neural network. At a high level, a neural network (1000) may be graphically depicted as being composed of nodes (1002), where here any circle represents a node, and edges (1004), shown here as directed lines. The nodes (1002) may be grouped to form layers (1005). FIG. 10 displays four layers (1008, 1010, 1012, 1014) of nodes (1002) where the nodes (1002) are grouped into columns, however, the grouping need not be as shown in FIG. 10. The edges (1004) connect the nodes (1002). Edges (1004) may connect, or not connect, to any node(s) (1002) regardless of which layer (1005) the node(s) (1002) is in. That is, the nodes (1002) may be sparsely and residually connected. A neural network (1000) will have at least two layers (1005), where the first layer (1008) is considered the “input layer” and the last layer (1014) is the “output layer”. Any intermediate layer (1010, 1012) is usually described as a “hidden layer”. A neural network (1000) may have zero or more hidden layers (1010, 1012) and a neural network (1000) with at least one hidden layer (1010, 1012) may be described as a “deep” neural network or as a “deep learning method”. In general, a neural network (1000) may have more than one node (1002) in the output layer (1014). In this case the neural network (1000) may be referred to as a “multi-target” or “multi-output” network.

Nodes (1002) and edges (1004) carry additional associations. Namely, every edge is associated with a numerical value. The edge numerical values, or even the edges (1004) themselves, are often referred to as “weights” or “parameters”. While training a neural network (1000), numerical values are assigned to each edge (1004). Additionally, every node (1002) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) ,$$

where i is an index that spans the set of “incoming” nodes (1002) and edges (1004) and ƒ is a user-defined function. Incoming nodes (1002) are those that, when viewed as a graph (as in FIG. 10), have directed arrows that point to the node (1002) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (1002) in a neural network (1000) may have a different associated activation function. Often, as a shorthand, activation functions are described by the function ƒ by which it is composed. That is, an activation function composed of a linear function ƒ may simply be referred to as a linear activation function without undue ambiguity.

When the neural network (1000) receives an input, the input is propagated through the network according to the activation functions and incoming node (1002) values and edge (1004) values to compute a value for each node (1002). That is, the numerical value for each node (1002) may change for each received input. Occasionally, nodes (1002) are assigned fixed numerical values, such as the value of 1, that are not affected by the input or altered according to edge (1004) values and activation functions. Fixed nodes (1002) are often referred to as “biases” or “bias nodes” (1006), displayed in FIG. 10 with a dashed circle.

In some implementations, the neural network (1000) may contain specialized layers (1005), such as a normalization layer, or additional connection procedures, like concatenation. One skilled in the art will appreciate that these alterations do not exceed the scope of this disclosure.

As noted, the training procedure for the neural network (1000) comprises assigning values to the edges (1004). To begin training the edges (1004) are assigned initial values. These values may be assigned randomly, assigned according to a prescribed distribution, assigned manually, or by some other assignment mechanism. Once edge (1004) values have been initialized, the neural network (1000) may act as a function, such that it may receive inputs and produce an output. As such, at least one input is propagated through the neural network (1000) to produce an output. Training data is provided to the neural network (1000). Generally, training data consists of pairs of inputs and associated targets. The targets represent the “ground truth”, or the otherwise desired output, upon processing the inputs. In the context of the instant disclosure, an input is a seismic dataset and its associated target is a bandwidth extended seismic dataset. During training, the neural network (1000) processes at least one input from the training data and produces at least one output. Each neural network (1000) output is compared to its associated input data target. The comparison of the neural network (1000) output to the target is typically performed by a so-called “loss function”; although other names for this comparison function such as “error function”, “misfit function”, and “cost function” are commonly employed. Many types of loss functions are available, such as the mean-squared-error function, however, the general characteristic of a loss function is that the loss function provides a numerical evaluation of the similarity between the neural network (1000) output and the associated target. The loss function may also be constructed to impose additional constraints on the values assumed by the edges (1004), for example, by adding a penalty term, which may be physics-based, or a regularization term (not be confused with regularization of seismic data). Generally, the goal of a training procedure is to alter the edge (1004) values to promote similarity between the neural network (1000) output and associated target over the training data. Thus, the loss function is used to guide changes made to the edge (1004) values, typically through a process called “backpropagation”.

While a full review of the backpropagation process exceeds the scope of this disclosure, a brief summary is provided. Backpropagation consists of computing the gradient of the loss function over the edge (1004) values. The gradient indicates the direction of change in the edge (1004) values that results in the greatest change to the loss function. Because the gradient is local to the current edge (1004) values, the edge (1004) values are typically updated by a “step” in the direction indicated by the gradient. The step size is often referred to as the “learning rate” and need not remain fixed during the training process. Additionally, the step size and direction may be informed by previously seen edge (1004) values or previously computed gradients. Such methods for determining the step direction are usually referred to as “momentum” based methods.

Once the edge (1004) values have been updated, or altered from their initial values, through a backpropagation step, the neural network (1000) will likely produce different outputs. Thus, the procedure of propagating at least one input through the neural network (1000), comparing the neural network (1000) output with the associated target with a loss function, computing the gradient of the loss function with respect to the edge (1004) values, and updating the edge (1004) values with a step guided by the gradient, is repeated until a termination criterion is reached. Common termination criteria are: reaching a fixed number of edge (1004) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (1004) values are no longer intended to be altered, the neural network (1000) is said to be “trained.”

In accordance with one or more embodiments, the AI engine (208) implements the sentiment analysis (214) of the chatbot (204). As an example of the importance and use of sentiment analysis (214) by the management consultant digital assistant system (200), consider the case of a project manager implementing an organizational transformation. Often, the project manager is under a lot of pressure and must perform many tasks to both initiate changes and check the progress of the organizational change. It is well known that the feelings (or sentiment) of the project manager impact the success of an organizational transformation. Thus, the sentiment of members of an affected organization are indicators of broader factors that are directly related to the success of an organizational transformation. Through detection of user sentiment, the AI engine (208) may apply weightings to the sequence and order of the actions and or tasks in the recommended change management plan (242). Using the determined sentiment of a user, the management consulting digital assistant system (200) may advise shortening or lengthening time periods associated with various events in the schedule (244) or even removing/adding specific steps. For example, a user's stress may indicate a desired organizational transformation is more urgent than originally stated or that the user needs to calm down and reflect. In the latter case, the management consultant digital assistant system (200) can aid the user in slowly tackling interventions and, in some instances, launch a new executive communications/stakeholder engagement plan.

In accordance with one or more embodiments, the management consultant digital assistant system (200) analyzes user sentiment over time through both interactions with one or more users through the chatbot (204) and through pulse surveys (226). Depending on the sentiment analysis (214), the AI engine (208) learn and advise different project tasks/steps, and even advise scheduling likely task efforts and timelines, alongside optimum decisions for scheduling/planning. This is a potentially unique factor not directly considered in conventional organizational transformation planning. Further, in one or more embodiments, sentiment analysis (214) is used as a prediction tool when assessing the adoption of new working practices according to, and following, the change management plan (242).

In general, sentiment analysis (214) is considered an NLP classification task. In one or more embodiments, the AI engine (208) (or the chatbot (204), when performing sentiment analysis (214), can accept typed text, pdf documents, and/or voice data. The sentiment analysis (214) task involves classifying the received data into sentiments, such as positive or negative, happy, sad or neutral, etc. Thus, the ultimate goal of sentiment analysis (214) is to decipher the underlying mood, emotion, or sentiment of the received data. In the literature, sentiment analysis (214) may be known as opinion mining. For example, the sentiment analysis may detect stress, sarcasm, etc.

Many sentiment analyses (214) algorithms exist. Known tools include, but are not limited to: “Text Blob”; vectorization or embedding models; long short-term memory (LSTM)-based models, transformer models, and the valence aware dictionary for sentiment reasoning (VADER) algorithm. The VADER algorithm measures the valence and magnitude of emotion in text. The valence of emotion refers to whether it is positive or negative. The magnitude of emotion refers to how positive or negative the text is. VADER also identifies text that is not emotional or neutral in its valence.

Many sentiment analyses (214) algorithms, including the VADER algorithm, are tuned to find sentiment at the sentence level such that these algorithms parse sentences individually and then return an average compound sentence score for groups of sentences (i.e., paragraphs, documents, etc.). In one or more embodiments, the sentiment analysis (214), performed by the management consultant digital assistant system (200), and implemented by the AI engine (208) and/or chatbot (204), is the VADER algorithm. In these embodiments, user-chatbot interactions and pulse surveys (226) are classified as either “positive,” “neutral,” or “negative.” In one or more embodiments, deep learning model and the output of the deep learning model is processed with a sigmoid activation function. The sigmoid activation function produces values in the range of [−1,1]. In one or more embodiments, a max negative classification threshold and a min positive classification threshold are used to partition the range of the sigmoid function into “positive,” “neutral,” and “negative” categories. In other embodiments, these categories are probabilistically modelled using a multi-output AI model with a final softmax activation function.

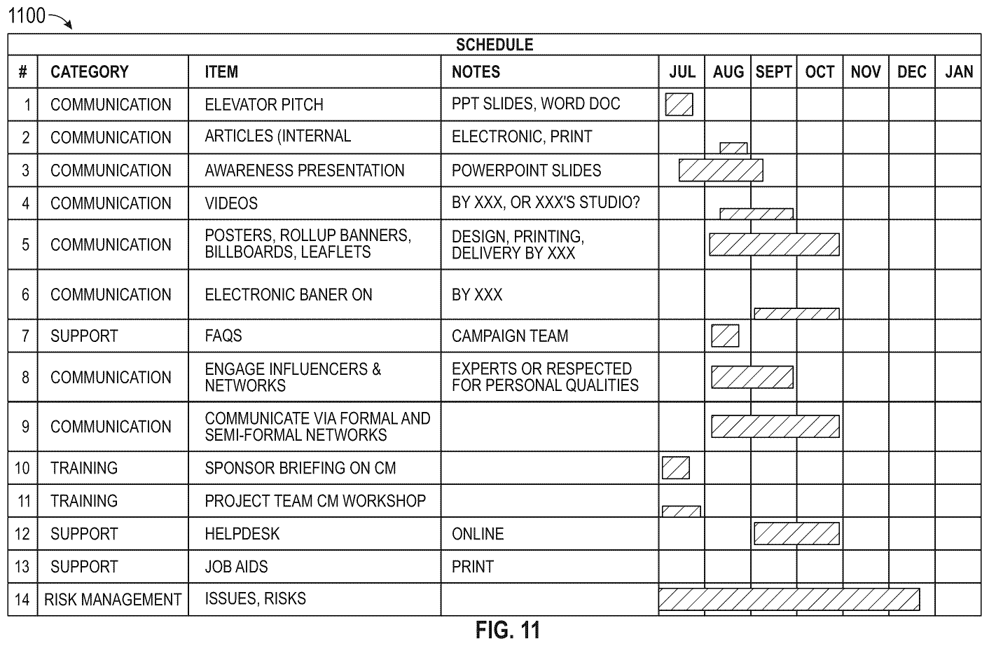

The principal output of the AI engine (208) is a change management plan (242), which is provided to the user, or users, through the resource server (232). Upon probing the user for the desired organizational transformation, acquiring data surrounding the organization and stakeholders, assessing organizational and user readiness, determining user sentiment, and comparing the received data (and derived quantities (240)) with the knowledge database (248), the AI engine (208) outputs a tailored change management plan (242). The change management plan outlines all the activities that must be performed, and stakeholders that should implement and/or receive products of the activities, in order to efficiently realize the desired organizational transformation. In particular, the change management plan (242) organizes the custom-suggested activities according to a schedule (244). In accordance with one or more embodiments, FIG. 11 depicts an example schedule (1100) produced by and provided to the user using the management consultant digital assistant system (200). As seen in the example schedule (1100), the schedule (244) included in the change management plan (242) categorizes the type of activity (e.g., communication, support, training, etc.), defines the activity to be performed (e.g., creation of slide deck, electronic notification), and indicates the timeline in which the activity should be performed.

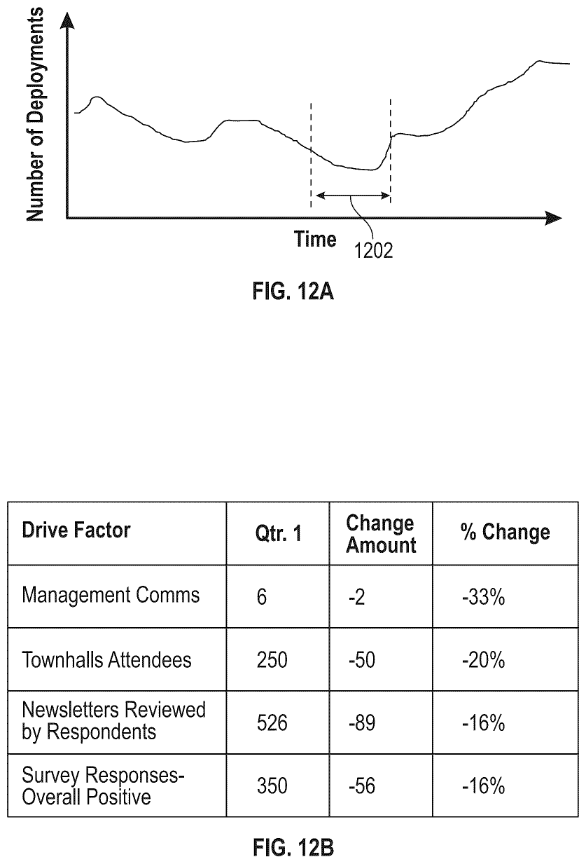

In accordance with one or more embodiments, the management consultant digital assistant system (200) further includes a monitoring system (260). The monitoring system (260) tracks the implementation of the organizational transformation according to the generated change management plan (242). In one or more embodiments, the change management plan (242) defines key performance indicators (KPIs). The KPIs provide a measure (quantitative or qualitative) of the success of the organizational transformation, or activities of the organizational transformation, during and throughout implementation. Activities that can be tracked and scored include, but are not limited to the occurrence of weekly standups, monthly stakeholder and management meetings, ad hoc requests, coaching, training and surveys, and scheduled communications. As such, each KPI can be scored. Thus, the KPI scores (264) provide a real-time assessment of an organizational transformation. The monitoring system (260) tracks and records the KPI scores (264). Further, in one or more embodiments, the monitoring system (260) identifies KPI with poor performance using one or more anomaly and/or outlier detection algorithms implemented by the AI engine (208). As an example, consider the case where an identified KPI (as identified by the change management plan (242)) is the number of computers (or computational systems) where a software is being deployed. FIG. 12A depicts an example plot demonstrating the number of deployments of software over a period of time. The monitoring system (260) checks for anomalous values outside an expected range, where the expected range may be determined by the AI engine (208) and algorithm of choice. In one or more embodiments, outliner and anomaly detection ranges are dynamic and can vary with time. That is, the monitoring system (260) can efficiently track transient and non-stationary signals. In most cases, the expected result and/or range is based on historic trends over a specified time period. The monitoring system (260) operates by comparing the current value for the KPI to the expected range and/or result. This comparison factors in previous trends and considers seasonality. Algorithms employed for this task may include, but are not limited to: STL; S-ARIMA; ARIMA; random forest; and PCA. In one or more embodiments, multiple algorithms are used simultaneously and ensembled to enhance prediction performance.

In one or more embodiments, the monitoring system (260) searches for anomalies on a monthly basis and will only search for anomalies when presented with at least 7 months of data. In one or more embodiments, outliers are determined by comparison of the KPI value to a moving average. In one or more embodiments, a KPI score is determined to be an outlier if it resides outside the interquartile range (IQR) for the KPI, historically. In one or more embodiments, outliers are also detected using shorter time periods. For example, time periods such as 2 days, 2 weeks or 2 months may be used. Thus, the monitoring system (260) can identify outliers and/or anomalies over multiple time scales. FIG. 12A further depicts and time period (1202) where the number of deployments was determined by the monitoring system (260) to be statistically different/significant.

In addition to identifying outliers and/or anomalies, the monitoring system (260) can determine the root cause of a detected issue. In one or more embodiments, upon detecting an outlier/anomaly, the monitoring system (260) performs a root cause analysis (266). The root cause analysis (266) determines the factors that resulted in the outlier/anomaly. In one or more embodiments, the root cause analysis (266) evaluates changes in recorded data metrics over various data segments. Data segments may include department, type of staff, employee ID, staff position, years of experience, employee group name, office location, etc. FIG. 12B depicts the quarterly change of some typical data metrics, where the time period is aligned with the anomalous time period (1202) of FIG. 12A. In the present example, the root cause analysis (266) may determine that a communication breakdown resulted in the curtailment of software deployments because “management communications” showed the largest percent decrease over the anomalous time period (1202). In one or more embodiments, the AI engine (208) directs the user to preferred schedules and plans, emphasizes the importance of maintaining these actions, reinforces linkages to benchmarking and best practices and training content via the discovery tool (246) and the knowledge database (248). In one or more embodiments, the AI engine (208) alters (or adapts) the change management plan (242) according to the detected outliers/anomalies and the root cause analysis (266). In other words, the AI engine (208) can propose interventions and actions to reduce risk and bring organizational transformation back on track.

The monitoring system further provides report generation (268) and alarm (262) functionalities. Alarms (262) simply refer to alerting one or more users if an issue is detected and/or if an alteration to the change management plan (242) or proposed action is recommended by the AI engine (208). Alarms (262) may take the form of chatbot (204) notifications/interactions and/or email and SMS notifications. The monitoring system (260) also generates a detailed report (268) describing the identified issue, underlying analysis, and recommendation in greater detail. The report may be displayed to the user through the user interface (202), made available to download through a link provided by the chatbot (204), and/or distributed to one or more users via email.

In accordance with one or more embodiments, the management consultant digital assistant system (200) further includes a skills center (270). The skills center (270) can use the organizational and user readiness assessments (230), if available, or administer a knowledge assessment to one or more users to determined gaps in user skill sets compared to the skillset required for a successful organizational transformation. In one or more embodiments, the skill center (270), upon identifying gaps in a user's knowledge, proposes one or more training resources to the user. In one or more embodiments, the training resource are selected from the learning resources (254) of the knowledge database. In one or more embodiments, the training resources are served to the user through resource sever (232). The resource sever can deliver any multimedia format (210), such as audio-video learning resources (254). The skills center (270) may further link with internal and/or external certification programs (274). Thus, a user may demonstrate competency in a given skill or knowledge area. In one or more embodiments, the monitoring system (260) interacts with the skills center (270) to ensure that users are completing required training according to the schedule (244) outlined in the change management plan (242).

In accordance with one or more embodiments, the management consultant digital assistant system (200) further includes a user community interface (280), which allows subject matter experts (SME) to review historical and ongoing organizational transformations, identify best practices that should be promoted in future organizational transformations, and provide real-time feedback and adaptions to ongoing organizational transformations. The user community interface (280) tags and categorized SMEs according to their field of expertise. Further the user community interface allows SMEs to subscribe to organizational transformations being overseen by the management consultant digital assistant system (200) and allows users to request feedback from SMEs. In one or more embodiments, SMEs are subscribed to the management consultant digital assistant system (200) and the user community interface (280) controls SME privileges and access to historical and ongoing organizational transformations. As such, the user community interface (280) enables SMEs to access topics or projects of interest, and have ability to view plans and projects and deliverables depending on their rights. In this way, the user community interface (208) provides an external quality assurance panel that continually and iteratively evaluates the change management plans (242) output by the AI engine (208). The SMEs have the ability to vote and score produced change management plans (242), and/or the individual activities that form the plan, and the schedule (244). Using the votes and scores from the SMEs through the user community interface (280), the AI engine (208) continually learns and improves. Moreover, the user community interface (280), through the user interface (202), enables direct user and SME communication in the form of discussion boards. As such, the user community interface (280) enables an organizational transformation virtual oversight and governance panel. In one or more embodiments, SME-recommended alterations to the change management plan (242) are parsed by the chatbot (204) and AI engine (208) in order to identify the best course of action to effect the desired organizational transformation.

In accordance with one or more embodiments, the SMEs, through the user community interface (280) complete surveys, based on their views of the overall change management plan (242), associated schedule (244), and KPI scores (264) to-date, and rank the overall effectiveness of the change management plan to enact the organizational transformation and propose suggestions for improvement and flag new best practices. This survey directly interacts with and has an iterative feedback loop with the knowledge database (248). For example, the actions/steps/interventions that are ranked highly will have a greater likelihood of being included in future change management plans (242) for similar organizational transformations. Further, highly ranked items are more likely to selected by the discovery tool (246) when searched for, or sought out, through a user-initiated question.

In accordance with one or more embodiments, the user community interface (280) further allows SMEs to promote, create, and advise on training programs by flagging desired skillsets in the skills center (270) and tagging and/or uploading high quality learning resources (254) in the knowledge database (248). As such, the SMEs can advise new skills and competency training needs for users and the management consultant digital assistant system (200) can flag areas of knowledge and capabilities that need improvement and point users to training knowledge areas.

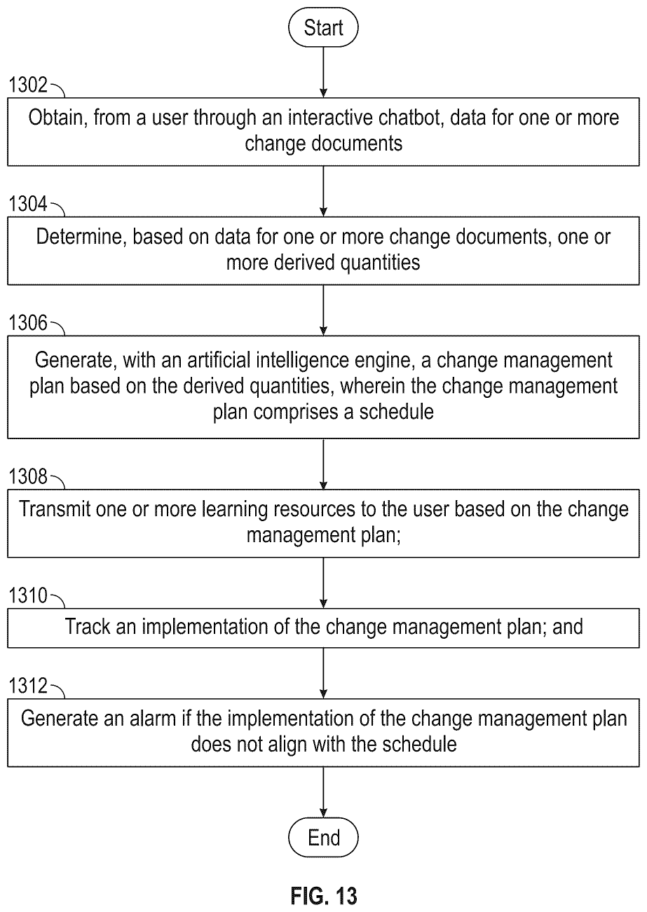

FIG. 13 depicts a method of use for the management consultant digital assistant system (200) in accordance with one or more embodiments. It is emphasized that a user may interact with and use the management consultant digital assistant system (200) at multiple points during the lifecycle of an organizational change. Thus, it will be well understood by one of ordinary skill in the art that the flow chart depicted in FIG. 13 does not imply that the associated blocks be performed in sequential order or limited to the blocks and order depicted. In Block 1302, the management consultant digital assistant system (200) obtains, through its chatbot (204) interacting with a user, data used to fill out the change documents (207) contained in the data layer (206). As the user interacts with the chatbot (204), the chatbot (204) parses and validates the entries of the user. Further, the chatbot (204) fills out the change documents (207), identifies relevant information that is required from the user, and structures an appropriate query from the user to obtain said information. In one or more embodiments, the change documents (207) are query generation are dynamically updated based on the previous responses received from the user. That is, some questions and or information described in one or more change documents (207) may become irrelevant or non-applicable based on user responses. In such a case, the chatbot (204) intelligently, does not probe the user for redundant or unnecessary information.

In one or more embodiments, the chatbot (204) employs sentiment analysis to determine the sentiment of a user. In one or more embodiments, the sentiment analysis is performed by the AI engine (208). In Block 1304, the data collected in the change documents (207) is used to determine one or more derived quantities (240). In one or more embodiments, the derived quantities (240) are further based on, or informed by, field device data where the field devices are part of an internet of things (IoT) cluster (236). In most cases, the derived quantities (240) are scores calculated according to a set of rules and/or mathematical functions (i.e., “hard coding”). That is, the data layer (206) includes a set of instructions for transforming the data within the change documents (207), which may be textual, to quantitative or qualitative indicators. In one or more embodiments, data received by the data layer (206) from the IoT cluster (236) is aggregated and/or combined with change document (207) data to form one or more derived quantities which may be continuous-valued or categorical. In Block 1306, the artificial intelligence (AI) engine (208) processes, at least, the derived quantities (240), which characterized the desired organizational transformation, the affected organization, and its users, to generate a change management plan (242). The change management plan (242) includes, at least, a schedule (244) where the schedule (244) outlines a timeline for a series of activities that should be performed to successfully realize the organizational transformation.

In one or more embodiments, the AI engine (208) generates the change management plan (242) by identifying similar historical change management plans and templates (252) in the knowledge database (248) using the discovery tool (246). In one or more embodiments, the change management plan (242) generated by the AI engine (208) is based on similar and high-ranking templates (252) in the knowledge database (248), where items in the knowledge database (248) are ranked by subject matter experts (SMEs) through the user community interface (280). In Block 1308, one or more learning resources (254) are selected from the knowledge database (248) and transmitted to the user. In one or more embodiments, items transmitted to the user are done so through the resource server (232) and, where possible, items are displayed to the user using the user interface (202). In one or more embodiments, learning resources (254) are supplied to the user based on organizational and user readiness assessments (230) and/or gap assessments (272).

In Block 1310, the change management plan (242) is implemented and tracked using the monitoring system (260). In one or more embodiments, the monitoring system (260) monitors key performance indicators (KPIs) using KPI scores (264) and detects outliers, anomalies, and/or poor performing KPIs. The monitoring system (260) further monitors the execution of activities and ensure that the schedule (244) of the change management plan (242) is followed. In Block 1312, if the monitoring system (260) determines that the implementation of the change management plan (242) does not align with the schedule (244) in a negative way (e.g., missed activity, delay, etc.) an alarm is raised and transmitted to the user along with recommended remedial actions. The remedial actions are recommended by the AI engine (208). In one or more embodiments, the contents of the knowledge database (248) and the generated change management plan (242) are continually reviewed and scored by a panel of subject matter experts (SMEs) through the user community interface (280). It is emphasized that the user (or users) of the management consultant digital assistant system (200) may interact with the management consultant digital assistant system (200) throughout the lifecycle of an organizational transformation. That is, the management consultant digital assistant system (200) is used to both coach, educate, and guide a user through the organizational transformation, providing 24/7 support without human bias.

Using the method of FIG. 13, the management consultant digital assistant creates an end to end transformation helping hand. The user may have a challenge, the system proposes solutions, leveraging one or more existing databases of case studies or wider community knowledge. The assistant provides the user with step by step tools, techniques, targeted training, prepopulated templates, real time onward project tracking interventions and knowledge to drive a successful change transformation program. Applications of embodiments disclosed herein may include downstream drilling systems, Business and Strategic Transformation projects, for example.

Those skilled in the art will appreciate that although the system discussed in embodiments disclosed herein uses the discipline of change management to provide a narrative of how this will assist end users in constructing an effective change management plan, it has a wider applicability in the other areas such as project management, management consulting, strategy development, mergers and acquisitions, etc.

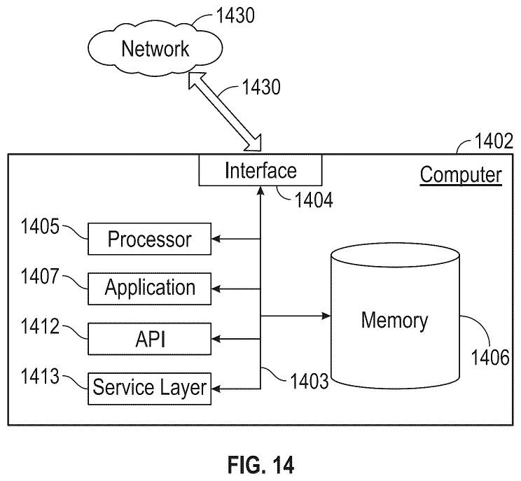

FIG. 14 further depicts a block diagram of a computer system (1402) (e.g., the pressure control system) used to provide computational functionalities associated with the methods, functions, processes, flows, and procedures as described in this disclosure, according to one or more embodiments. The illustrated computer (1402) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1402) may include a computer that includes an input device, such as a keypad, keyboard, touch screen, or other device that can accept user information, and an output device that conveys information associated with the operation of the computer (1402), including digital data, visual, or audio information (or a combination of information), or a GUI.

The computer (1402) can serve in a role as a client, network component, a server, a database or other persistency, or any other component (or a combination of roles) of a computer system for performing the subject matter described in the instant disclosure. In some implementations, one or more components of the computer (1402) may be configured to operate within environments, including cloud-computing-based, local, global, or other environment (or a combination of environments).

At a high level, the computer (1402) is an electronic computing device operable to receive, transmit, process, store, or manage data and information associated with the described subject matter. According to some implementations, the computer (1402) may also include or be communicably coupled with an application server, e-mail server, web server, caching server, streaming data server, business intelligence (BI) server, or other server (or a combination of servers).

The computer (1402) can receive requests over network (1430) from a client application (for example, executing on another computer (1402) and responding to the received requests by processing the said requests in an appropriate software application. In addition, requests may also be sent to the computer (1402) from internal users (for example, from a command console or by other appropriate access method), external or third-parties, other automated applications, as well as any other appropriate entities, individuals, systems, or computers.

Each of the components of the computer (1402) can communicate using a system bus (1403). In some implementations, any or all of the components of the computer (1402), both hardware or software (or a combination of hardware and software), may interface with each other or the interface (1404) (or a combination of both) over the system bus (1403) using an application programming interface (API) (1412) or a service layer (1413) (or a combination of the API (1412) and service layer (1413). The API (1412) may include specifications for routines, data structures, and object classes. The API (1412) may be either computer-language independent or dependent and refer to a complete interface, a single function, or even a set of APIs. The service layer (1413) provides software services to the computer (1402) or other components (whether or not illustrated) that are communicably coupled to the computer (1402). The functionality of the computer (1402) may be accessible for all service consumers using this service layer. Software services, such as those provided by the service layer (1413), provide reusable, defined business functionalities through a defined interface. For example, the interface may be software written in JAVA, C++, or other suitable language providing data in extensible markup language (XML) format or another suitable format. While illustrated as an integrated component of the computer (1402), alternative implementations may illustrate the API (1412) or the service layer (1413) as stand-alone components in relation to other components of the computer (1402) or other components (whether or not illustrated) that are communicably coupled to the computer (1402). Moreover, any or all parts of the API (1412) or the service layer (1413) may be implemented as child or sub-modules of another software module, enterprise application, or hardware module without departing from the scope of this disclosure.

The computer (1402) includes an interface (1404). Although illustrated as a single interface (1404) in FIG. 14, two or more interfaces (1404) may be used according to particular needs, desires, or particular implementations of the computer (1402). The interface (1404) is used by the computer (1402) for communicating with other systems in a distributed environment that are connected to the network (1430). Generally, the interface (1404) includes logic encoded in software or hardware (or a combination of software and hardware) and operable to communicate with the network (1430). More specifically, the interface (1404) may include software supporting one or more communication protocols associated with communications such that the network (1430) or interface's hardware is operable to communicate physical signals within and outside of the illustrated computer (1402).

The computer (1402) includes at least one computer processor (1405). Although illustrated as a single computer processor (1405) in FIG. 14, two or more processors may be used according to particular needs, desires, or particular implementations of the computer (1402). Generally, the computer processor (1405) executes instructions and manipulates data to perform the operations of the computer (1402) and any algorithms, methods, functions, processes, flows, and procedures as described in the instant disclosure.

The computer (1402) also includes a memory (1406) that holds data for the computer (1402) or other components (or a combination of both) that can be connected to the network (1430). The memory may be a non-transitory computer readable medium. For example, memory (1406) can be a database storing data consistent with this disclosure. Although illustrated as a single memory (1406) in FIG. 14, two or more memories may be used according to particular needs, desires, or particular implementations of the computer (1402) and the described functionality. While memory (1406) is illustrated as an integral component of the computer (1402), in alternative implementations, memory (1406) can be external to the computer (1402).

The application (1407) is an algorithmic software engine providing functionality according to particular needs, desires, or particular implementations of the computer (1402), particularly with respect to functionality described in this disclosure. For example, application (1407) can serve as one or more components, modules, applications, etc. Further, although illustrated as a single application (1407), the application (1407) may be implemented as multiple applications (1407) on the computer (1402). In addition, although illustrated as integral to the computer (1402), in alternative implementations, the application (1407) can be external to the computer (1402).

There may be any number of computers (1402) associated with, or external to, a computer system containing computer (1402), wherein each computer (1402) communicates over network (1430). Further, the term “client,” “user,” and other appropriate terminology may be used interchangeably as appropriate without departing from the scope of this disclosure. Moreover, this disclosure contemplates that many users may use one computer (1402), or that one user may use multiple computers (1402).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining, from a user through an interactive chatbot, data for one or more change documents, wherein the data is parsed and validated by a data validator of the chatbot and the one or more change documents are dynamically updated as data is received;
determining, based on data for one or more change documents, one or more derived quantities;
generating, with an artificial intelligence (AI) engine, a change management plan based on the derived quantities, wherein the change management plan comprises a schedule;
transmitting one or more learning resources to the user based on the change management plan;
tracking an implementation of the change management plan; and
generating an alarm when the implementation of the change management plan does not align with the schedule.

2. The method of claim 1, further comprising:
generating one or more pre-populated change documents wherein the pre-populated change documents are pre-populated based on the data;
transmitting the one or more pre-populated change documents to the user; and
completing, through interaction of the chatbot and the user, the one or more pre-populated change documents.

3. The method of claim 1, further comprising:
monitoring one or more key performance indicators of the change management plan;
predicting, using the AI engine, a performance of the change management plan based on the key performance indicators;
detecting an outlier or poor performing key performance indicator using the AI engine;
generating an alarm to the user identifying the outlier or poor performing key performance indicator; performing a root cause analysis, by the AI engine, to determine the cause of the outlier or poor performing key performance indicator;
recommending an intervention to correct the outlier or poor performing key performance indicator; and
generating a report detailing the root cause analysis and transmitting the report to the user.

4. The method of claim 1, further comprising:
comparing the data and derived quantities to documents in a knowledge database, wherein the change management plan is based, in part, a comparison of the derived quantities and the documents in the knowledge database.

5. The method of claim 1, further comprising:
receiving a score for the change management plan, wherein the score is provided by one or more subject matter experts; and
updating the change management plan, with the AI engine, based on the score.

6. The method of claim 1, further comprising:
determining a gap assessment;
identifying one or more learning resources from a knowledge database based on the gap assessment;
transmitting the one or more learning resources to the user; and
administering a test to the user based on the gap assessment and one or more learning resources.

7. A management consultant digital assistant system, comprising:
a user interface;
a chatbot, wherein the chatbot is configured to receive and transmit data from a user through the user interface;
a data layer, wherein the data layer comprises one or more change documents, wherein the change documents are dynamically populated by the user through interaction with the user interface and chatbot;
a knowledge database;
an artificial intelligence (AI) engine that implements one or more AI algorithms, wherein the AI engine processes the change documents of the data layer and the knowledge database to generate a change management plan comprising a schedule; and
a monitoring system, wherein the monitoring system tracks one or more key performance indicators (KPIs) during an implementation of the change management plan.

8. The management consultant digital assistant system of claim 7, further comprising:
a resource server that transmits, at least, the change management plan to the user.

9. The management consultant digital assistant system of claim 7, wherein derived quantities are calculated using the one or more change documents, and wherein the monitoring system further tracks KPI scores, activity scores, sentiment sores, and organizational transformation scores.

10. The management consultant digital assistant system of claim 7, further comprising: an internet of things (IoT) cluster comprising one or more interconnected field devices, wherein the one or more interconnected field devices are configured to transmit field device data wherein the field device data is used to assess the implementation of the change management plan.

11. The management consultant digital assistant system of claim 7, further comprising: a skills center, wherein the skills center continually identifies, using the AI engine, gaps in one or more skills of the user and provides one or more learning resources to the user.

12. The management consultant digital assistant system of claim 7, wherein the monitoring system, upon detecting an outlier or poor performing KPI, performs a root cause analysis to determine a cause of the outlier or poor performing KPI.

13. The management consultant digital assistant system of claim 12, wherein upon detection of the outlier or poor performing KPI the monitoring system generates an alarm to the user comprising a recommendation to remedy the outlier or poor performing KPI.

14. The management consultant digital assistant system of claim 7, wherein the user interface is a graphical user interface.

15. A non-transitory computer-readable memory comprising computer-executable instructions stored thereon that, when executed on a processor, cause the processor to perform a method comprising:
obtaining, from a user through an interactive chatbot, data for one or more change documents, wherein the data is parsed and validated by a data validator of the chatbot and the one or more change documents are dynamically updated as data is received;
determining, based on data for one or more change documents, one or more derived quantities;
generating, with an artificial intelligence engine, a change management plan based on the derived quantities, wherein the change management plan comprises a schedule;
transmitting one or more learning resources to the user based on the change management plan;
tracking an implementation of the change management plan; and
generating an alarm if the implementation of the change management plan does not align with the schedule.

16. The non-transitory computer-readable memory of claim 15, wherein the method further comprises:
generating one or more pre-populated change documents wherein the pre-populated change documents are pre-populated based on the data;
transmitting the one or more pre-populated change documents to the user; and
completing, through interaction of the chatbot and the user, the one or more pre-populated change documents.

17. The non-transitory computer-readable memory of claim 15, wherein the method further comprises:
monitoring one or more key performance indicators of the change management plan;
predicting, using the AI engine, a performance of the change management plan based on the key performance indicators;
detecting an outlier or poor performing key performance indicator using the AI engine;
generating an alarm to the user identifying the outlier or poor performing key performance indicator;
performing a root cause analysis, by the AI engine, to determine the cause of the outlier or poor performing key performance indicator;
recommending an intervention to correct the outlier or poor performing key performance indicator; and
generating a report detailing the root cause analysis and transmitting the report to the user.

18. The non-transitory computer-readable memory of claim 15, wherein the method further comprises:
comparing the data and derived quantities to documents in a knowledge database, wherein the change management plan is based, in part, a comparison of the derived quantities and the documents in the knowledge database.

19. The non-transitory computer-readable memory of claim 15, wherein the steps further comprise:
receiving a score for the change management plan, wherein the score is provided by one or more subject matter experts; and
updating the change management plan, with the AI engine, based on the score.

20. The non-transitory computer-readable memory of claim 15, wherein the method further comprises:
determining a gap assessment;
identifying one or more learning resources from a knowledge database based on the gap assessment;
transmitting the one or more learning resources to the user; and
administering a test to the user based on the gap assessment and one or more learning resources.
